(19) United States
(12) Patent Application Publication
(10) Pub. No.: US 2015/0153936 A1
(43) Pub. Date: Jun. 4, 2015

(54) INTEGRATED MULTIMEDIA DEVICE FOR VEHICLE

(71) Applicant: Hyundai Mobis Co., Ltd., Yongin-si (KR)

(72) Inventors: Mi jung LIM, Yongin-si (KR); Dong A Oh, Yongin-si (KR)

(21) Appl. No.: 14/522,242

(22) Filed: Oct. 23, 2014

(30) Foreign Application Priority Data
Nov. 29, 2013 (KR) 10-2013-0146839

(51) Int. Cl. G06F 3/0484; G06F 3/0482; G06F 3/01

(52) U.S. Cl. CPC G06F 3/04842; G06F 3/017; G06F 3/0482

(57) ABSTRACT

An integrated multimedia device for a vehicle includes a display device, an instrument cluster, and a user input device. The display device is configured to provide at least one of a digital multimedia broadcasting (DMB) function and a navigation function. The display device is further configured to detect touch inputs. The instrument cluster is configured to display content from the display device in response to a user input. The user input device is configured to manipulate at least one of the display device and the instrument cluster in response to detection of a touch input.

### CROSS-REFERENCE TO RELATED APPLICATION

This application claims priority from and the benefit of Korean Patent Application No. 10-2013-0146839, filed on Nov. 29, 2013, which is incorporated by reference for all purposes as if set forth herein.

### BACKGROUND

1. Field

Exemplary embodiments relate to an integrated multimedia device for a vehicle, and, more particularly, to an integrated multimedia device for a vehicle that may be operated in conjunction with an instrument cluster and a method of controlling the same.

2. Discussion of the Background

A vehicle may include a multimedia device configured to provide a digital multimedia broadcasting (DMB) function and a navigation function. A display unit of the multimedia device may be incorporated as part of a center fascia of the vehicle. With the display unit being incorporated as part of the center fascia, various functions may be provided, such as, for example, the DMB function, the navigation function, a temperature adjustment function, a multimedia playback function, etc. It is noted, however, that because a screen of the display unit may be relatively size, and because the display unit and an instrument cluster of the vehicle do not communicate information with one another, the attention of a driver may be distracted during operation or information retrieval, which may cause an accident. For instance, the driver may need to perform a touch input while watching the screen and may need to bend their body downward to manipulate the screen. In this manner, the risk of an accident may increase, especially when the driver attempts to drive the vehicle and manipulate the display unit at the same time.

It is also noted that in conventional vehicles only simple control keys, such as a key for adjusting volume and a mute key associated with a multimedia device are provided on a steering wheel. In this manner, it may be inconvenient for the driver to manipulate the multimedia device. As the frequency of use of the multimedia device for performing, for example, navigation features, phone calls, multimedia functions, etc., increases while the vehicle is in transit, it may be necessary to operate the multimedia device and the instrument cluster in conjunction with one another.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide an integrated multimedia device for a vehicle operated in conjunction with an instrument cluster.

Additional aspects will be set forth in the detailed description which follows, and, in part, will be apparent from the disclosure, or may be learned by practice of the inventive concept.

According to exemplary embodiments, an integrated multimedia device for a vehicle includes a display device, an instrument cluster, and a user input device. The display device is configured to provide at least one of a digital multimedia broadcasting (DMB) function and a navigation function. The display device is configured to detect touch inputs. The instrument cluster is configured to display content from the display device in response to a user input. The user input device is configured to manipulate at least one of the display device and the instrument cluster in response to detection of a touch input.

According to exemplary embodiments, a method includes: causing, at least in part, a user input to a system of a vehicle to be detected, the system being configured to provide at least one of a digital multimedia broadcasting (DMB) function and a navigation function; determining, in response to detection of the user input, an operation corresponding to the user input; and generating, in accordance with the operation, a control signal configured to affect the display of content via at least one of a display device and an instrument cluster of the system.

According to exemplary embodiments, user convenience of a multimedia device may be improve via enablement of various types of user inputs, such as touch inputs to a screen of the multimedia device, touch inputs to a touch pad mounted on a steering wheel of the vehicle, and gesture inputs detected via one or more sensors. In this manner, a driver of the vehicle may perform an input action without directly interacting with the screen of the multimedia device, which may increase user convenience and safety when the driver is driving the vehicle, as well as reduce the potential for driver distraction. Furthermore, because the instrument cluster may output content received from the multimedia device, the driver may drive the vehicle and acquire information from the multimedia device without directing attention to the screen of the multimedia device, and, thereby, away from a direction of travel.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a view of a cockpit of a vehicle including an integrated multimedia device, according to exemplary embodiments.

FIG. 2 is a block diagram of the integrated multimedia device of FIG. 1, according to exemplary embodiments.

FIGS. 3A and 3B are views of an analog instrument cluster, according to exemplary embodiments.

FIGS. 3C and 3D are views of a digital instrument cluster, according to exemplary embodiments.

FIGS. 4A, 4B, and 4C are views of a display device, according to exemplary embodiments.

FIG. 5A is a view of a first user input unit, according to exemplary embodiments.

FIGS. 5B, 5C, 5D, and 5E are views of a second user input unit, according to exemplary embodiments.

FIGS. 6A, 6B, and 6C are views of the display device to illustrate a method of controlling the integrated multimedia device of FIG. 1, according to exemplary embodiments.

FIGS. 7A and 7B are views of the display device to illustrate another method of controlling the integrated multimedia device of FIG. 1, according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. In the accompanying figures, the size and relative sizes of various components, devices, elements, etc., may be exaggerated for clarity and descriptive purposes. Also, like reference numerals denote like elements.

When a component, device, element, etc., is referred to as being “on,” “connected to,” or “coupled to” another component, device, element, etc., it may be directly on, connected to, or coupled to the other component, device element, etc., or intervening components, devices, elements, etc., may be present. When, however, a component, device, element, etc., is referred to as being “directly on,” “directly connected to,” or “directly coupled to” another component, device, element, etc., there are no intervening components, devices, elements, etc., present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms first, second, etc., may be used herein to describe various components, devices, elements, regions, etc., these components, devices, elements, regions, etc., are not to be limited by these terms. These terms are used to distinguish one component, device, element, region, etc., from another component, device, element, region, etc. In this manner, a first component, device, element, region, etc., discussed below may be termed a second component, device, element, region, etc., without departing from the teachings of the present disclosure.

Spatially relative terms, such as “beneath,” “below,” “lower,” “above,” “upper,” and the like, may be used herein for descriptive purposes, and, thereby, to describe one component, device, element, or feature's relationship to another component(s), device(s), element(s), or feature(s) as illustrated in the drawings. Spatially relative terms are intended to encompass different orientations of an apparatus in use, operation, and/or manufacture in addition to the orientation depicted in the drawings. For example, if an apparatus in the drawings is turned over, components described as “below” or “beneath” other components would then be oriented “above” the other components. In this manner, the exemplary term “below” can encompass both an orientation of above and below. Furthermore, an apparatus may be otherwise oriented (e.g., rotated 90 degrees or at other orientations), and, as such, the spatially relative descriptors used herein are to be interpreted accordingly.

The terminology used herein is for the purpose of describing exemplary embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, devices, regions, and/or groups thereof, but do not preclude the presence or addition of one or more other features, integers, steps, operations, elements, components, devices, regions, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

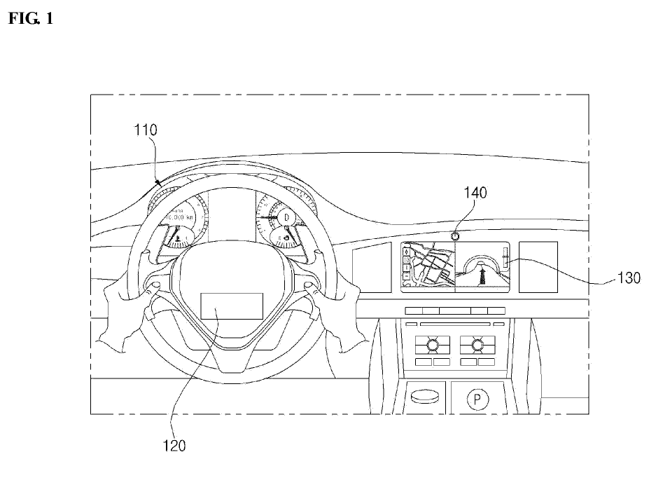

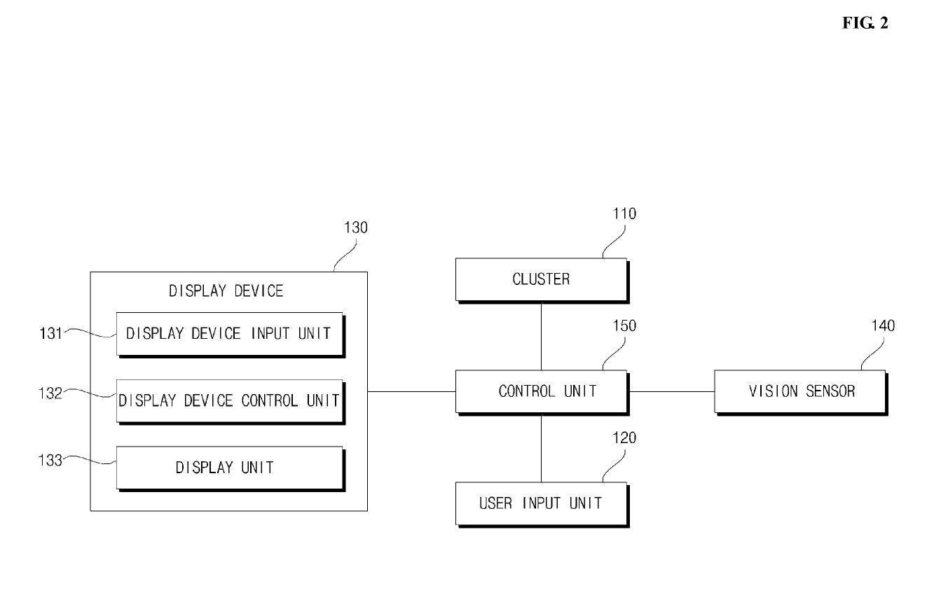

FIG. 1 is a view of a cockpit of a vehicle including an integrated multimedia device, according to exemplary embodiments. FIG. 2 is a block diagram of the integrated multimedia device of FIG. 1.

Referring to FIGS. 1 and 2, the integrated multimedia device for a vehicle may include an instrument cluster 110, a user input unit 120, a display device 130, a vision (or optical) sensor 140, and a control unit 150. Although specific reference will be made to this particular implementation, it is also contemplated that the integrated multimedia device may embody many forms and include multiple and/or alternative components. For example, it is contemplated that the components of the integrated multimedia device may be combined, located in separate structures, and/or separate locations.

The instrument (or gauge) cluster 110 is a module that displays various types of information regarding a vehicle. Hereinafter, instrument cluster 110 will be referred to as simply cluster 110. For instance, the cluster 110 may display information regarding (or otherwise associated with) a speed of the vehicle and a revolution per minute (RPM) of an engine of the vehicle. In addition, the cluster 110 may display trip information regarding a traveling distance, fuel consumption, and/or the like. The cluster 110 may display information regarding a travelable distance and fuel consumption, such as instantaneous fuel consumption and average fuel consumption. It is also contemplated that the cluster 110 may display information regarding various types of states and/or operational components of the vehicle, such as opened states of a door and/or a trunk, an operating state of a lamp, an operating state of a side (or emergency) brake, an operating state of a wiper, a warning signal associated with a component (e.g., airbag, door, engine, gate, ignition, light, sunroof, tire, window, etc.) of the vehicle, an operating state of a feature (e.g., a cruise control feature, a blind spot monitoring feature, a transmission position feature, a traction control feature, a fluid monitoring feature, etc.), and/or the like. To this end, the cluster 110 may provide information concerning vehicle maintenance, date and/or time information, and/or the like.

According to exemplary embodiments, the cluster 110 may output and display contents provided (or otherwise received) from the display device 130. For example, the cluster 110 may display information regarding navigation, digital multimedia broadcasting (DMB), multimedia file playing, radio, etc., information, that are provided from the display device 130.

In exemplary embodiments, a user of the vehicle may manipulate an operation of the cluster 110 using, for instance, the user input unit 120. The user may be a driver or other type of occupant of the vehicle. The user input unit 120 may be a touch pad mounted on a steering wheel. It is also contemplated that the user input unit 120 may be disposed (or otherwise integrated) as part of a console unit, an integrated control system, a fascia, etc.

It is contemplated that a user of the vehicle may interact with the user input unit 120 to control aspects of the instrument cluster 110 and/or the display device 130. For example, a user may perform a multi-touch input to the user input unit 120, and, thereafter, perform a pinch-in input or a pinch-out input in a state in which navigational information is displayed via the cluster 110. In this manner, a map displayed via the cluster 110 may zoom in or zoom out. As another example, a user may perform a multi-touch input to the user input unit 120, and thereafter, perform a drag input in a predetermined direction in a state in which information regarding a playing multimedia file is displayed via the cluster 110. In this manner, a screen of the cluster 110 may display information regarding a next file to be played or a previous file that was already played. In yet another example, a user may perform a touch input to the user input unit 120, and, thereafter, perform a drag input in a predetermined direction in a state in which navigational information is displayed via the cluster 110. In this manner, the screen of the cluster 110 may be converted to a DMB screen or a radio screen. It is also contemplated that a user may perform a multi-touch input to the user input unit 120 using three or more (e.g., five) fingers, and, thereafter, perform a drag input collecting the respective touch inputs of the fingers to one position, in a state in which predetermined contents are displayed via the cluster 110. As such, a main menu may be displayed via the cluster 110. It is noted, however, that various other and/or alternative inputs may be performed to control the display of information via cluster 110.

According to exemplary embodiments, the display device 130 may include a display device input unit 131, a display device control unit 132, and a display unit 133. The display unit 133 and the display device input unit 131 may mutually have a layered structure, and may be configured as a touch screen. In this manner, the display unit 133 may serve as the display device input unit 131. It is contemplated, however, that additional and/or alternative forms of display device input units 131 may be utilized in association with display device 130, such as, for example, buttons, dials, levers, touch surfaces, wheels, etc. For descriptive purposes, however, the display unit 133 (and associated functions thereof) will be, hereinafter, considered in association with a touch screen implementation. The display device control unit 132 receives input from a user to the display device input unit 131 or the display unit 133, and controls the display device input unit 131 or the display unit 133 in order to perform a predetermined operation or function.

The display device 130 may be mounted in a region of a center fascia (or dashboard) and may be configured to display various types of information. For example, the display device 130 may display operating states of various types of buttons of (or positioned on or in) the center fascia. For instance, when a user operates an air conditioner or a heater by manipulating a button of the center fascia, the display device 130 may display an operating state of the air conditioner or the heater. The display device 130 may include a navigation function, a DMB function, a radio function, a multimedia file playing function, and/or the like. In response to detecting a user interaction with (or manipulation of) an input device associated with the display device (e.g., the display device input unit 131), the navigation, DMB, radio, multimedia file playing, etc., functions may be performed.

In exemplary embodiments, the interaction or manipulation of an input device may be a touch-based input to the display unit 133. For example, a user may perform a touch input to a map region displayed via display unit 133, and, thereafter, may perform a drag input in a downward direction in a state in which a map of the navigation feature is displayed in an upper region of the display unit 133 and the main menu is displayed in a middle region of the display unit 133. In response thereto, the display device control unit 132 may control the display unit 133 to display the navigation map on an overall screen of the display unit 133. As another example, when a user performs a drag input after a multi-touch input, the display device control unit 132 may control the menu screen to be changed. In this manner, the menu screen may be changed while having three-dimensional spatial characteristics. According to another example, a user may perform a pinch-in input or a pinch-out input in a state in which the navigation map is displayed via display unit 133. As such, the display device control unit 132 may control the map so that the map zooms in or zooms out. In a further example, a user may perform a multi-touch input at three or more (e.g., five) points of the display unit 133, and, thereafter, perform a drag input in a state in which a predetermined operation screen is displayed. As such, the control unit 150 may control the cluster 110 so that content provided from the display device 130 may be displayed via the cluster 110.

According to exemplary embodiments, the vision sensor 140 may include one or more cameras, and may be configured to sense a gesture of the user. It is also contemplated that the vision sensor 140 may include a motion sensor, charge-coupled device, etc. The vision sensor 140 transmits the sensed gesture of the user to the control unit 150. The control unit 150 transmits a control signal to the display device 130 so that the display device 130 may perform an operation that corresponds (or otherwise mapped) to the gesture of the user that is received from the vision sensor 140. The display device 130, which has received the control signal from the control unit 150, may perform an operation that corresponds to the gesture of the user.

In exemplary embodiments, the vision sensor 140 senses an operation of the user when the user waves a hand (e.g., a right hand or a left hand) in an upward, downward, leftward, or rightward direction. The hand may be an opened hand, as will become more apparent below. For example, a gesture of the user may be sensed by the vision sensor 140 when the user lowers their hand in a downward direction in a state in which their hand is opened. In this manner, the control unit 150 may transmit a control signal, which corresponds to the gesture, to the display device 130. The display device 130, which has received the control signal, may perform an operation of displaying the map of the navigational feature on the display unit 133 while corresponding to the gesture. It is contemplated, however, that any other suitable operation/function may be performed.

For example, a gesture of the user may be sensed by the vision sensor 140 when the user raises their hand in an upward direction in a state in which the hand of the user is opened. As such, the control unit 150 may transmit a control signal, which corresponds to the gesture, to the display device 130. The display device 130, which has received the control signal, may perform an operation of displaying a quick menu screen on the display unit 133 while corresponding to the gesture. As another example, a gesture of the user may be sensed by the vision sensor 140 when the user moves their hand in a leftward or rightward direction in a state in which the hand of the user is opened. In this manner, the control unit 150 may transmit a control signal, which corresponds to the gesture, to the display device 130. As such, the display device 130 may perform an operation of changing the menu, which is currently activated, to another menu or other function. In another example, the vision sensor 140 may sense a gesture of the user when the user stops moving their hand for a predetermined (or set) period of time in a state in which the hand of the user is opened. As such, the control unit 150 may control the cluster 110 so that content provided from the display device 130 to the cluster 110 is displayed via the cluster 110.

According to exemplary embodiments, the control unit (or controller) 150 controls operations of the cluster 110, the user input unit 120, the display device 130, and the vision sensor 140. When the control unit 150 receives an input signal from the user input unit 120, the vision sensor 140, or the display device input unit 131, the control unit 150 may transmit a control signal, which corresponds to the input signal, to the display device 130, the cluster 110, and/or any other suitable component of the vehicle.

In exemplary embodiments, the cluster 110, the user input unit 120, the display device 130, the vision sensor 140, the control unit 150, and/or one or more components thereof, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like. As such, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, the cluster 110, the user input unit 120, the display device 130, the vision sensor 140, the control unit 150, and/or one or more components thereof may include or otherwise be associated with one or more memories (not shown) including code (e.g., instructions) configured to cause the cluster 110, the user input unit 120, the display device 130, the vision sensor 140, the control unit 150, and/or one or more components thereof to perform one or more of the features, functions, processes, etc., described herein.

Although not illustrated, the memories may be any medium that participates in providing code to the one or more software, hardware, and/or firmware components for execution. Such memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CDRW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

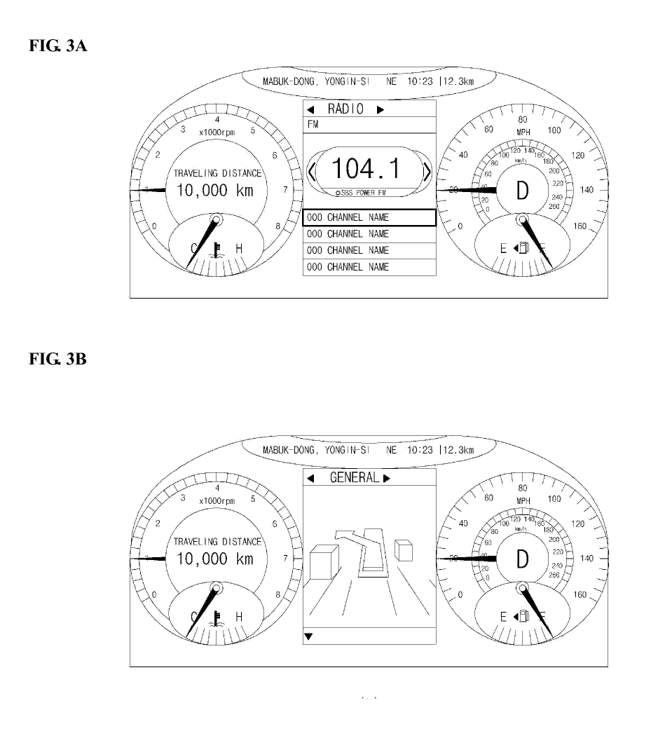

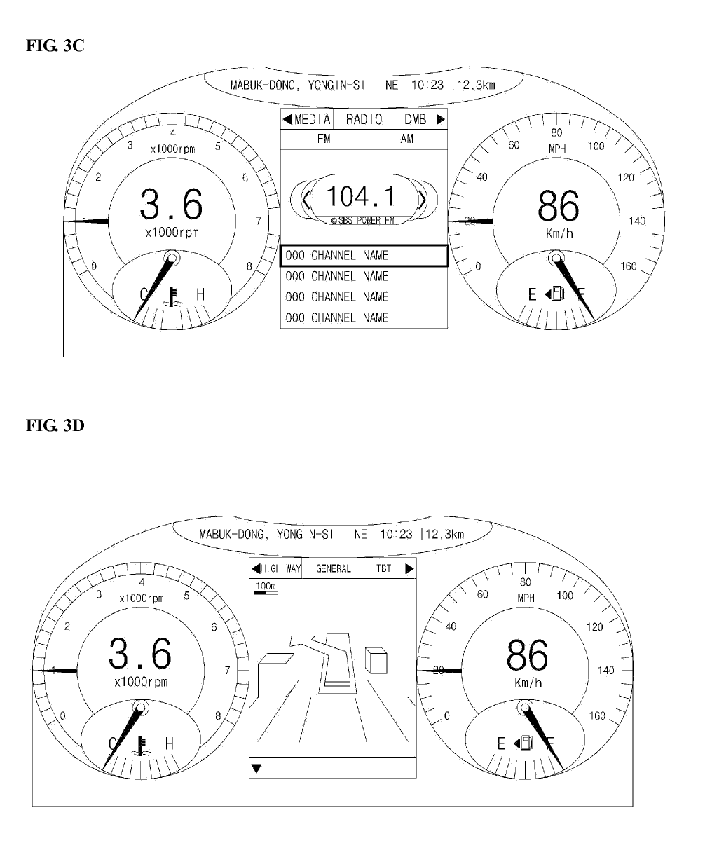

FIGS. 3A and 3B are views of an analog instrument cluster, according to exemplary embodiments.

As illustrated in FIG. 3A, the cluster 110 may display a speed, an RPM, a traveling distance, an amount of fuel (or fuel level) of the vehicle, whether a lamp is operated, an opened state of a door, a temperature of the engine, a position of the transmission, and/or the like. The speed and the RPM of the vehicle may be displayed in an analog manner, e.g., via an analog gauge. The fuel level and the temperature of the engine may also be displayed in an analog manner. In this manner, it is contemplated that the cluster 110 may include one or more screens to output other information, e.g., the traveling distance, the position of the transmission, etc. The cluster 110 may be operated in conjunction with the display device 130, and may display a radio frequency that is being received or available for tuning. The cluster 110 may be operated in conjunction with the navigation feature of the display device 130, and may display a current position and direction of the vehicle.

As illustrated in FIG. 3B, the cluster 110 may display a map of the navigation feature of the display device 130, as well as one or more of the informational elements previously described in association with FIG. 3A.

FIGS. 3C and 3D are views of a digital instrument cluster, according to exemplary embodiments.

As illustrated in FIG. 3C, the cluster 110 may display a speed, an RPM, a traveling distance, an amount of fuel of the vehicle, whether a lamp is operated, an opened state of a door, a temperature of the engine, a position of the transmission, and/or the like. It is noted, however, that the various informational elements (e.g., the speed of the vehicle, the RPM of the vehicle, etc.) may be displayed in a digital manner, such as, via one or more screens. In addition, the cluster 110 may be operated in conjunction with the display device 130, and may display a radio frequency that is being received or available for tuning. The cluster 110 may be operated in conjunction with the navigation feature of the display device 130, and may display a current position and direction of the vehicle.

As illustrated in FIG. 3D, the cluster 110 may display a map of the navigation feature of the display device 130, as well as one or more of the informational elements previously described in association with FIG. 3C.

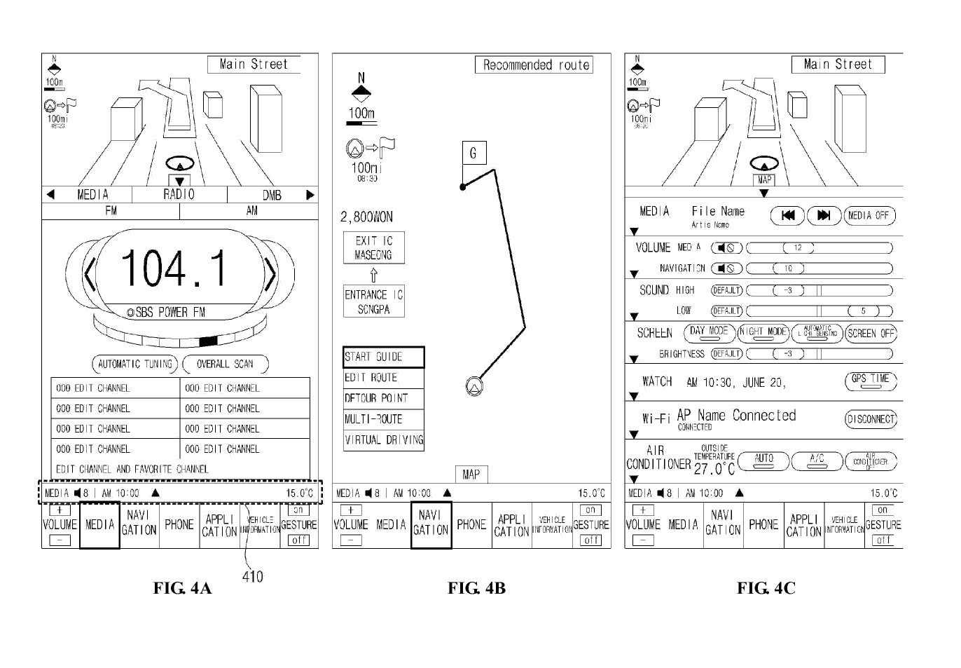

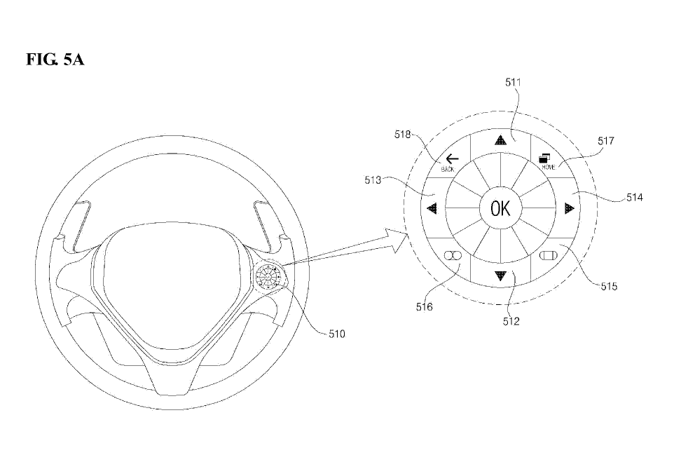

FIGS. 4A, 4B, and 4C are views of a display device, according to exemplary embodiments.

As illustrated in FIG. 4A, a map of the navigation feature may be displayed in an upper region of the display unit 133 of the display device 130. A radio frequency, which is being received, may be displayed in a middle region of the display unit 133 of the display device 130. A plurality of radio frequencies, which is stored in advance, may be displayed in the middle region of the display unit 133 of the display device 130. A region for adjusting volume, a region for displaying content that is currently being activated (or played), and a region for setting gesture modes may be displayed in a lower region of the display unit 133 of the display device 130.

In exemplary embodiments, when a drag input in a downward direction is received after a touch input to the region where the navigation map is displayed, the navigation map may be enlarged and displayed, such as illustrated in FIG. 4B. When, for example, a drag input in an upward direction is received in the screen illustrated in FIG. 4A after a touch input to a quick setting region 410 is provided, a quick setting mode screen of the display device may be displayed, such as illustrated in FIG. 4C. The quick setting mode screen may include screens for setting media files, adjusting volume, adjusting sound, adjusting a screen, adjusting a watch, setting Bluetooth, setting wireless fidelity (Wi-Fi), setting an air conditioner, etc., may be displayed. The aforementioned settings may be performed via the quick setting mode screen through one or more touch inputs of the user.

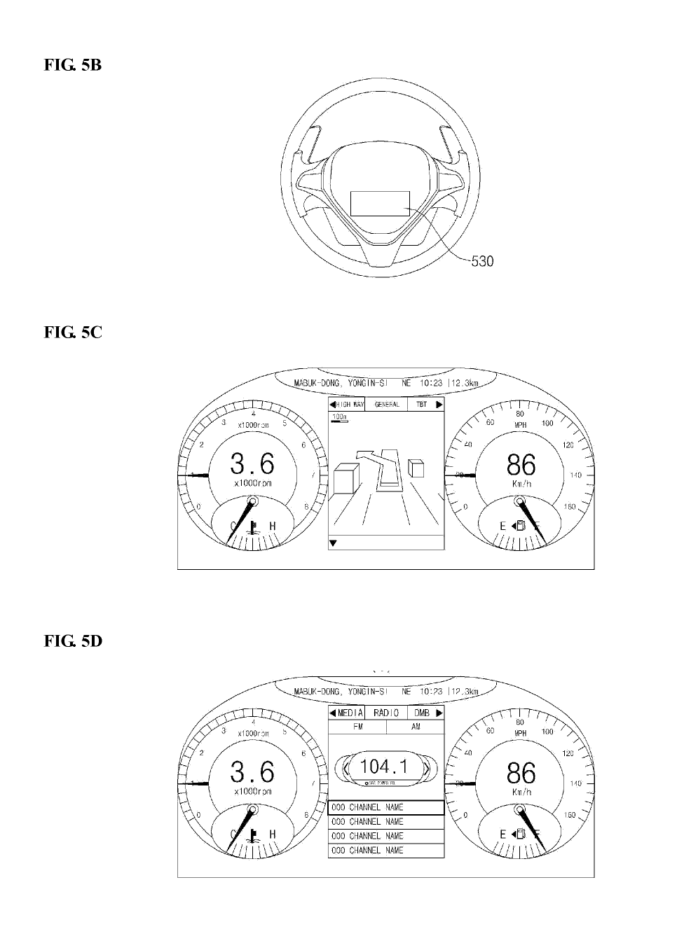

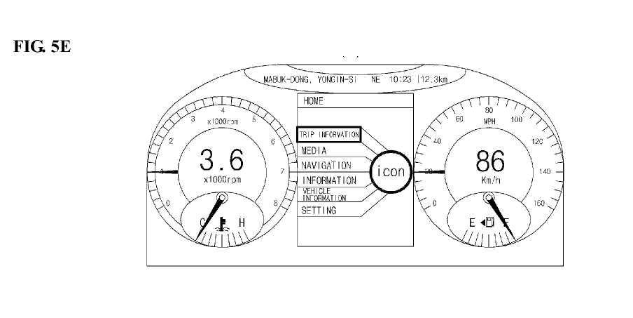

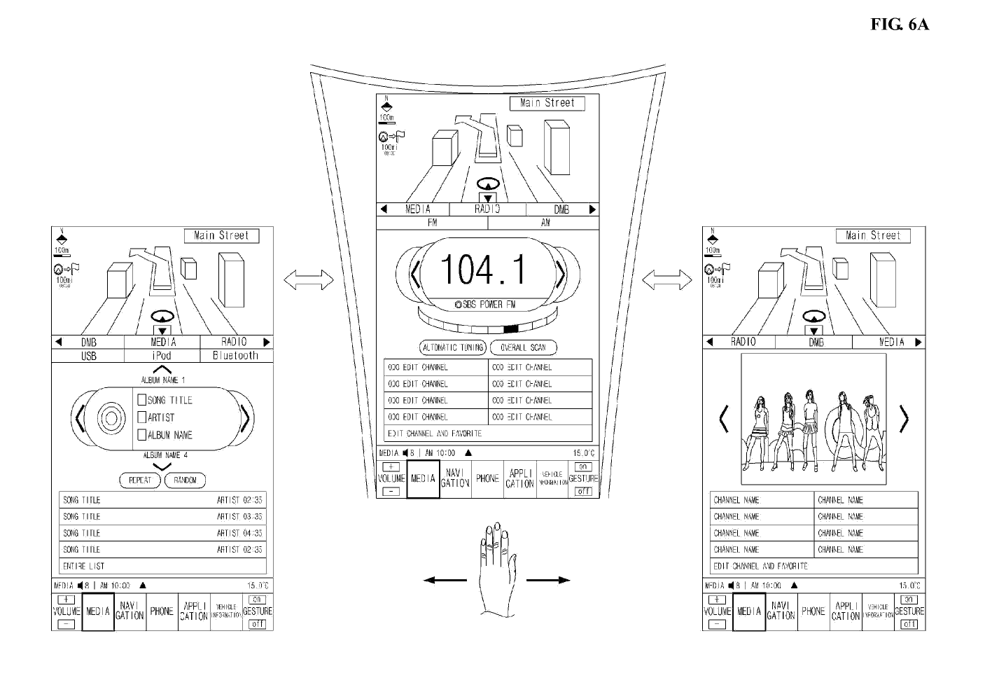

FIG. 5A is a view of a first user input unit, according to exemplary embodiments.

Referring to FIG. 5A, the user input unit 510 may be mounted as part of a steering wheel of the vehicle, e.g., at a left side of the steering wheel, so that a driver may easily manipulate the user input unit 510 using the thumb of their right hand. The user input unit 510 may include first to fourth buttons 511, 512, 513, and 514, cluster type conversion buttons 515, and 516, a home button 517, and a back key 518.

When an input of the first button 511 is received, the screen displayed on the cluster 110 may be converted from the main menu screen to the map screen of the navigation feature. When an input of the second button 512 is received, the screen displayed on the cluster 110 may be converted from the map screen of the navigation feature to the main menu screen of the user interface. When an input of the third button 513 and an input of the fourth button 514 are received, the screen displayed on the cluster 110 may be converted into another menu. In instances when an input of the cluster type conversion buttons 515 and 516 is received, the screen displayed on the cluster 110 may be converted and displayed from the analog cluster to the digital cluster or converted from the digital cluster to the analog cluster. When an input of the home button 517 is received, the screen displayed on the cluster 110 may be converted into the main menu screen. When an input of the back key 518 is received, the screen displayed on the cluster 110 may be converted into a previous screen.

FIGS. 5B, 5C, 5D, and 5E are views of a second user input unit, according to exemplary embodiments.

As illustrated in FIG. 5B, the user input unit may be a touch pad 530 mounted in a region of the steering wheel. The user may manipulate an operation of the cluster 110 using the touch pad 530. Again, the user is an occupant of the vehicle.

According to exemplary embodiments, when the occupant performs a multi-touch input to the touch pad 530, and, thereafter, performs a pinch-in input or a pinch-out input in a state in which the navigation feature is displayed via the cluster 110, a map displayed via the cluster 110 may zoom in or zoom out. As another example, when the occupant performs a multi-touch input to the touch pad 530, and, thereafter, performs a drag input in a predetermined direction in a state in which information regarding a playing multimedia file is displayed via the cluster 110, the cluster screen may display information regarding a next file playing or previously played file. In another example, when the occupant performs a touch input to the touch pad 530, and, thereafter, performs a drag input in an upward direction in a state in which a radio receiving frequency is displayed via the cluster, such as illustrated in FIG. 5D, the cluster screen may be converted into a navigation screen, such as illustrated in FIG. 5C.

According to exemplary embodiments, when the occupant performs a touch input to the touch pad 530, and, thereafter, performs a drag input in a downward direction in a state in which the navigation feature is displayed via the cluster 110, such as illustrated in FIG. 5C, the cluster screen may be converted into a DMB screen or a radio screen, such as illustrated in FIG. 5D. In another example, when the occupant performs a multi-touch input to the touch pad 530 using three or more (e.g., five) fingers, and, thereafter, performs a drag input to collect the respective touch inputs to one position in a state in which predetermined content is displayed via the cluster 110, a main menu may be displayed via the cluster screen, such as illustrated in FIG. 5E.

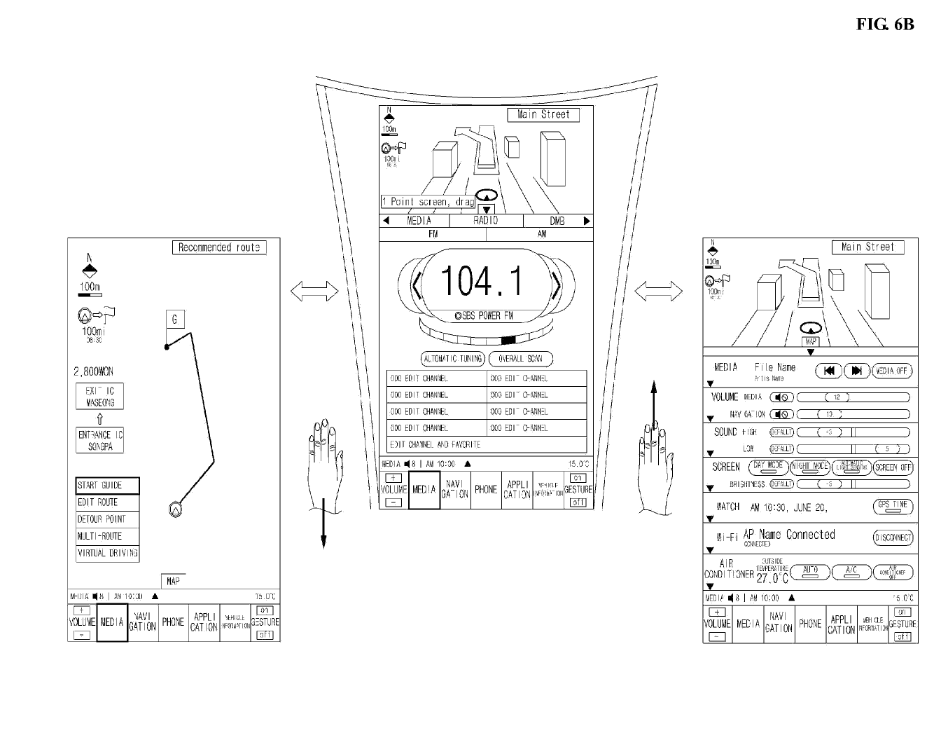

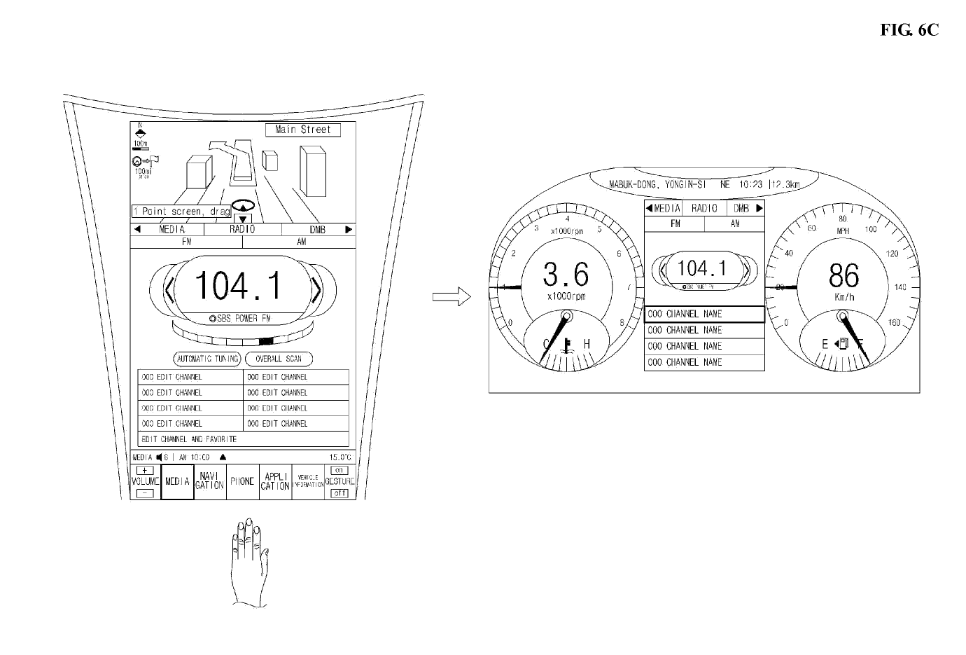

FIGS. 6A, 6B, and 6C are views of the display device to illustrate a method of controlling the integrated multimedia device of FIG. 1, according to exemplary embodiments.

Referring to FIG. 6A, the display device 130 may display a radio frequency, which is being received, in a middle region of the display unit 133. As such, the occupant may move their left hand in a leftward direction in a state in which their left hand is opened. In this manner, the vision sensor 140 may sense and recognize the gesture as a valid user input, and the display device 130 may change the menu from a radio menu to a media menu. When the occupant opens the left hand and moves the opened left hand in a rightward direction in a state in which a radio frequency is displayed, the vision sensor 140 may receive and recognize the gesture as a valid user input, and the display device 130 may change the menu from the radio menu to a DMB menu.

Referring to FIG. 6B, the display device 130 may display a radio frequency, which is being received, in the middle region of the display unit 133. As such, the occupant may move their left hand downward in a state in which their left hand is opened. As such, the vision sensor 140 may sense and recognize the gesture as a valid user input, and the display device 130 may enlarge and display the navigation map. When the occupant opens their left hand and moves their opened left hand in an upward direction in a state in which a radio frequency is displayed, the vision sensor 140 may receive and recognize the gesture as a valid user input. In this manner, the display device 130 may display a quick menu setting screen.

Referring to FIG. 6C, the display device 130 may display a radio frequency, which is being received, in the middle region of the display unit 133. When, for example, the occupant stops moving their left hand for a predetermined period of time in a state in which their left hand is opened, the vision sensor 140 may sense and recognize the gesture as a valid user input. In this manner, content provided from the display device 130 to the cluster 110 may be displayed via the cluster 110.

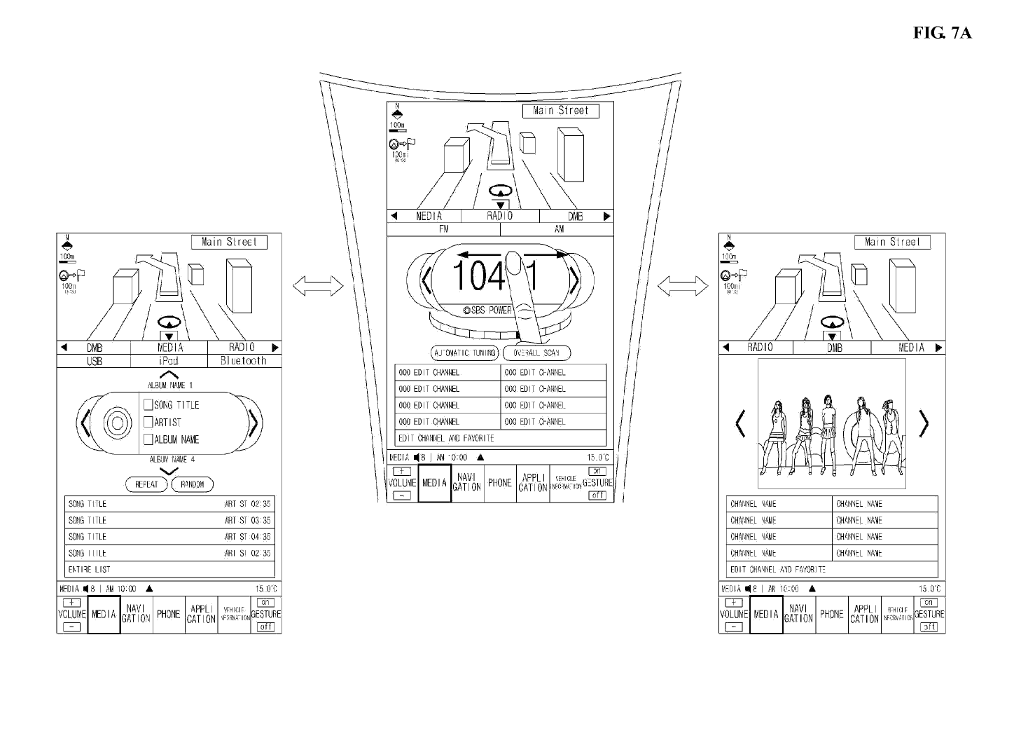

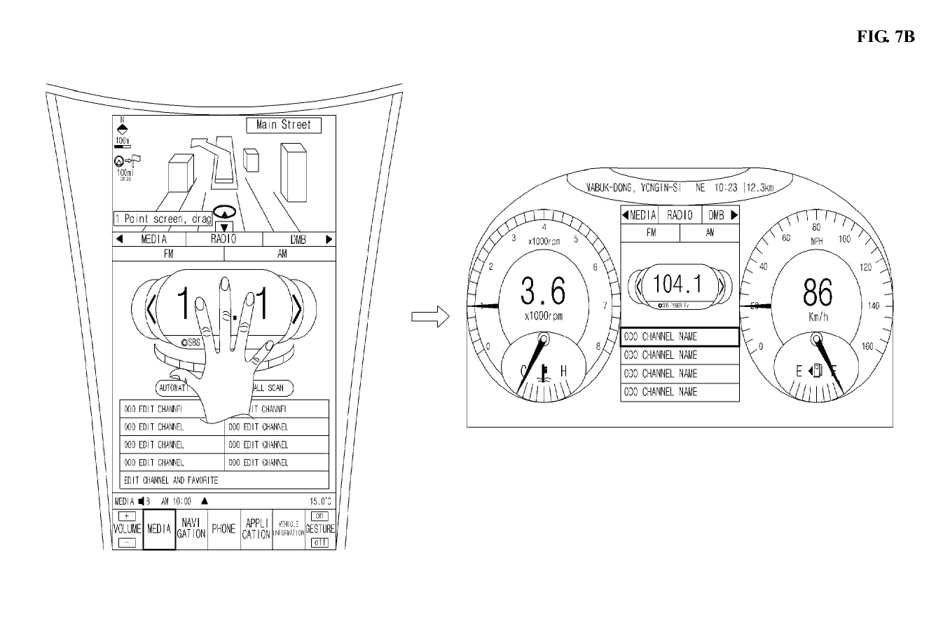

FIGS. 7A and 7B are views of the display device to illustrate another method of controlling the integrated multimedia device of FIG. 1, according to exemplary embodiments.

Referring to FIG. 7A, when drag input in a leftward direction is received after a touch input is received in a state in which the radio receiving frequency is displayed, the display device 130 may change the menu from the radio menu to the media menu. When a drag input in a rightward direction is received after a touch input is received in a state in which the radio receiving frequency function is displayed, the display device 130 may change the menu from the radio menu to the DMB menu.

Referring to FIG. 7B, the display device 130 may display a radio frequency, which is being received, in the middle region of the display unit 133. When the occupant inputs a multi-touch gesture for a predetermined period of time, a touch screen of the display device 130 may sense the touch gesture. In this manner, content provided from the display device 130 to the cluster 110 may be displayed via the cluster 110.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An integrated multimedia device for a vehicle, comprising:
a display device configured to provide at least one of a digital multimedia broadcasting (DMB) function and a navigation function, the display device being further configured to detect touch inputs;
an instrument cluster configured to display content from the display device in response to a user input; and
a user input device configured to manipulate at least one of the display device and the instrument cluster in response to detection of a touch input.

2. The integrated multimedia device of claim 1, further comprising:
a sensor configured to sense a gesture of an occupant of the vehicle,
wherein, in response to sensation of the gesture, the display device is configured to perform an operation corresponding to the gesture.

3. The integrated multimedia device of claim 2, wherein the gesture corresponds to an open-hand wave by the occupant in an upward, downward, leftward, or rightward direction.

4. The integrated multimedia device of claim 3, wherein, in response to detection of a termination of movement of the gesture for a set period of time, the instrument cluster is configured to output content received from the display device.

5. The integrated multimedia device of claim 1, wherein:
the user input device comprises a touch pad mounted on a steering wheel of the vehicle; and
the touch pad is configured to detect touch inputs.

6. The integrated multimedia device of claim 2, further comprising:
a controller configured to transmit a control signal to the display device or the instrument cluster in response to reception of an input signal via the user input device or the sensor, the control signal corresponding to the input signal.

7. The integrated multimedia device of claim 1, wherein the display device comprises a touch screen configured to detect touch inputs and display information.

8. The integrated multimedia device of claim 7, wherein, in response to detection of a multi-touch input for a set duration via the touch screen, the control unit is configured to control content displayed via the display device to be displayed via the instrument cluster.

9. The integrated multimedia device of claim 5, wherein the touch pad is configured to receive at least one of a touch input, a multi-touch input, a drag input, a pinch-in input, and a pinch-out input.

10. The integrated multimedia device of claim 1, wherein the instrument cluster is configured to display at least one of a navigation screen, a DMB screen, and a radio screen.

11. The integrated multimedia device of claim 1, wherein:
the vehicle comprises a steering wheel and a driver's seat; and
the steering wheel is disposed between the instrument cluster and the driver's seat.

12. A method, comprising:
causing, at least in part, a user input to a system of a vehicle to be detected, the system being configured to provide at least one of a digital multimedia broadcasting (DMB) function and a navigation function;
determining, in response to detection of the user input, an operation corresponding to the user input; and
generating, in accordance with the operation, a control signal configured to affect the display of content via at least one of a display device and an instrument cluster of the system.

13. The method of claim 12, further comprising:
causing, at least in part, the control signal to be transmitted to at least one of the display device and the instrument cluster.

14. The method of claim 12, wherein detection of the user input comprises:
causing, at least in part, a gesture to be detected via a sensor; and
determining that the gesture corresponds to a valid user input to the system.

15. The method of claim 14, wherein the gesture corresponds to an open-hand wave in an upward, downward, leftward, or rightward direction.

16. The method of claim 15, further comprising:
causing, at least in part, a termination of the open-hand wave to be detected via the sensor for a set period of time;
causing, at least in part, content to be transmitted to the instrument cluster via the display device; and
causing, at least in part, the content to be displayed via the instrument cluster.

17. The method of claim 12, wherein the user input is detected via a touch pad mounted on a steering wheel of the vehicle.

18. The method of claim 17, wherein the user input is at least one of a touch input, a multi-touch input, a drag input, a pinch-in input, and a pinch-out input.

19. The method of claim 12, wherein:
the user input is a multi-touch input to a touch screen of the display device for a set duration of time; and
the control signal is configured to cause content displayed via the display device to be displayed via the instrument cluster.

20. The method of claim 12, wherein the instrument cluster is configured to display at least one of a navigation screen, a DMB screen, and a radio screen.
